(19) United States
(12) Patent Application Publication
(10) Pub. No.: US 2002/0097108 A1
(43) Pub. Date: Jul. 25, 2002

(54) Transmission line to waveguide mode transformer

(76) Inventor: Nitin Jain, San Diego, CA (US)

Correspondence Address: Mr. Loyal M. Hanson, Hanson Law Corporation, P.O. Box 430, Fallbrook, CA, 92088-0430, US

(21) Appl. No.: 09/976,448

(22) Filed: Oct. 11, 2001

Related U.S. Application Data
(60) Provisional application No. 60/251,564, filed on Dec. 7, 2000.

(51) Int. Cl. H01P 5/08

(52) U.S. Cl. 333/26; 333/33

(57) ABSTRACT

An ultra broadband, low-loss, transmission line to waveguide mode transformer that can be implemented using PCB technology includes a dielectric substrate on which is disposed an electrically conductive pattern that forms a dielectric waveguide and a dielectric transmission line extending to the waveguide. The electrically conductive pattern includes a waveguide portion that forms the dielectric waveguide. It also includes a transmission line portion with first and second sections that form first and second segments of the dielectric transmission line. The second segment matches the first segment to the waveguide. It may have a greater width (lesser impedance) than the first section or a narrower width (greater impedance) in order to effect a match according to whether a capacitive or inductive matching structure is required.

### CROSS REFERENCE TO RELATED APPLICATION

This application claims the benefit of copending U.S. Provisional Application Serial No. 60/251,564 filed Dec. 7, 2000.

### BACKGROUND OF THE INVENTION

1. Technical Field

This invention relates generally to radio frequency (RF) circuits operating at millimeter-wave frequencies, and more particularly to a transmission line to waveguide mode transformer that can be conveniently implemented using printed circuit board (PCB) techniques.

2. Description of Related Art

Numerous commercial millimeter-wave systems require transmission line to waveguide mode transitions. The key requirements of such a transition are that it be compact in size, easy-to-manufacture, and process-tolerant for PCB compatible fabrication. Additionally, good electrical isolation is desired when multiple transitions from a substrate are required for a multi-beam system, such as, for example, an autonomous cruise control (ACC) system.

A number of such transitions have been proposed in the literature. The well-known transitions from microstrip to rectangular waveguide mode are the E-field probe method and the “ridge waveguide transition.” Both of them require modification to the waveguide and they put restrictions on the planar circuit design.

Recently, a number of transitions compatible with millimeter integrated circuits (MMIC) and microwave integrated circuits (MIC) processing have been proposed. While these new transitions provide a suitable technology for large-scale, low-cost manufacturing, the performance of the printed transition has been unsatisfactory in some respects. First, they have excessive loss (up to 2 dB) and/or a relatively narrow bandwidth. Second, the transitions are prone to cross talk and they are sensitive to manufacturing tolerances and operating environment.

U.S. Pat. No. 6,087,907 issued Jul. 11, 2000 to the inventor of the instant application, described a transverse electric or quasi-transverse electric mode to waveguide mode transformer using fins to provide a microstrip transmission line to rectangular waveguide mode conversion. The transition is tolerant of process and provides excellent broadband performance. In addition, since it does not rely on resonance phenomenon for coupling, it provides excelled isolation between two adjacent transitions. However, the bandwidth of the transition is limited and the fins occupy area and need good lithography. Thus, there remains a need for a transmission line to waveguide mode transformer for millimeter-wave frequency modules that is easy to manufacture, provides low loss, is tolerant to manufacturing variations, and exhibits a greater bandwidth.

### SUMMARY OF THE INVENTION

This invention addresses the need outlined above by providing a transmission line to a waveguide mode transformer with a matching structure that improves bandwidth. Described subsequently with reference to a microstrip to rectangular waveguide (MS-to-RW) mode transformer, or just transformer, it achieves the improved bandwidth with a matching section of the transmission line at the waveguide. The matching section is sized and shaped according to known techniques so that it has desired matching characteristics, thereby resulting in an ultra-broadband transition that does not rely on resonance phenomenon for coupling.

Thus, the transformer has significantly greater broadband performance. It exhibits excellent isolation between two adjacent transitions. It is process tolerant. It is readily fabricated with known PCB technology.

To paraphrase some of the more precise language appearing in the claims, a transmission line to waveguide mode transformer constructed according to the invention includes a dielectric substrate and an electrically conductive pattern on the substrate (e.g., deposited, evaporate, or rolled laminate). The electrically conductive pattern includes a waveguide potion that forms a dielectric waveguide, and a transmission line portion that forms a dielectric transmission line extending to the waveguide. The transmission line portion of the pattern includes first and second sections. The first section forms a first segment of the transmission line removed from the waveguide, while the second section forms a second segment or matching segment of the transmission line extending from the first segment to the waveguide. The second section of the transmission line portion of the pattern has a size and shape resulting in the second segment of the transmission line having characteristics that help match the first segment of the transmission line to the waveguide.

The first section of the transmission line portion of the electrically conductive pattern has a width resulting in a desired transmission line impedance (e.g., 50 Ohms). Depending on the design, the second section of the transmission line portion of the pattern may have a width that is wider than the first section so that the second segment of the transmission line has lower impedance than the first segment, or the second section of the transmission line portion of the pattern may have a width that is narrower than the first section so that the second segment of the transmission line has higher impedance that the first segment in order to match the transmission line to the waveguide. Fins are not necessary, broadbanded performance results, and the second section of the transmission line portion of the pattern may have a nonuniform width and use known PCB-implemented match-improving methods with multi-sections (i.e., shutcap-inductor-shutcap, etc.). The following illustrative drawings and detailed description make the foregoing and other objects, features, and advantages of the invention more apparent.

### BRIEF DESCRIPTION OF THE DRAWINGS

FIG. 1 of the drawings is an isometric view of a transmission line to waveguide mode transformer constructed according to the invention (not to scale), with the thickness of the electrically conductive pattern exaggerated for illustrative convenience and the orientation of an X-Y-Z Cartesian coordinate system depicted in the lower right-hand corner;

FIG. 2 is a slightly enlarged plan view of the transmission line to waveguide mode transformer (not to scale), with some of the waveguide portion of the pattern broken away to expose the far end portion of the substrate;

FIG. 3 is a cross sectional view of a first section of the transmission line portion of the pattern (not to scale) as viewed in a transverse plane perpendicular to the Y-axis that contains a line 3-3 in FIG. 2;

FIG. 4 is a cross sectional view of the second section (matching section) of the transmission line portion of the pattern (not to scale) as viewed in a transverse plane perpendicular to the Y-axis that contains a line 4-4 in FIG. 2;

FIG. 5 is a cross sectional view of the waveguide portion of the pattern (not to scale) as viewed in a transverse plane perpendicular to the Y-axis that contains a line 5-5 in FIG. 2;

FIG. 6A is a plot of S-parameters S₁₁ and S₂₁ for a MS-to-RW mode transformer without fins;

FIG. 6B is a plot of S-parameters S₁₁ and S₂₁ for a MS-to-RW mode transformer with one fin;

FIG. 6C is a plot of S-parameters S₁₁ and S₂₁ for a MS-to-RW mode transformer that uses some of the technology in U.S. Pat. No. 6,087,907 with two fins;

FIG. 6D is a plot of S-parameters S₁₁ and S₂₁ for a MS-to-RW mode transformer that uses some of the technology in U.S. Pat. No. 6,087,907 with three fins;

FIG. 7 is a plot of S-parameters S₁₁ and S₂₁ for the illustrated transmission line to waveguide mode transformer of the present invention, with the scale for S₂₁ magnified by a factor of ten for better visualization;

FIG. 8 is a plot of electromagnetic (EM) simulated and analytical S-parameters for a transmission line to waveguide mode transition without the matching structure of the present invention, the large dots indicating data points from the Z_{PI} equation subsequently described;

FIG. 9 is a plot of an EM-optimized transmission line to waveguide mode transition that includes a low impedance line and a capacitive stub; and

FIG. 10 is a plan view similar to FIG. 2 showing the pattern of a second embodiment in which the matching portion of the pattern is narrower than the first section of the transmission line portion.

### DESCRIPTION OF THE PREFERRED EMBODIMENTS

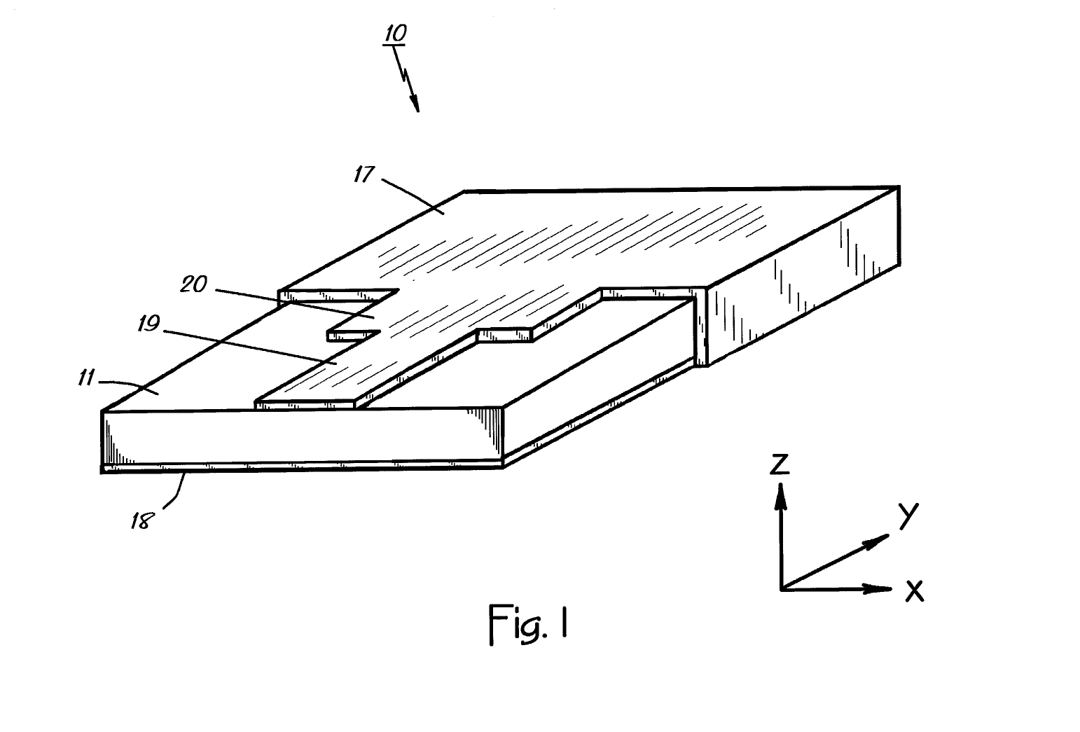

FIGS. 1-9 of the drawings show various aspects of a transmission line to waveguide mode transformer 10 constructed according to the invention. It is similar in some general respects to the transformer described in U.S. Pat. No. 6,087,907 issued Jul. 11, 2000 to the inventor of the instant application that is entitled “Transverse Electric or Quasi-Transverse Electric Mode to Waveguide Mode Transformer.” That patent is incorporated herein by this reference for the information it provides, including background information, construction and design details, and MS-to-RW mode transition understandings.

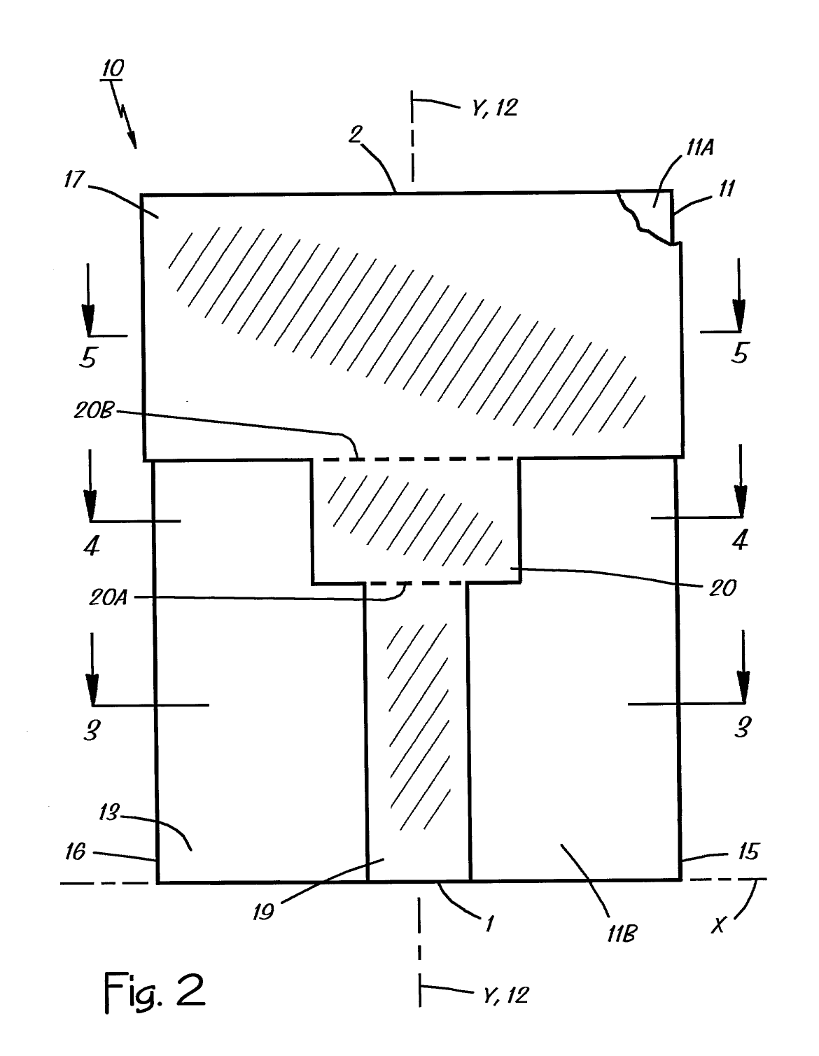

The transformer 10 includes important differences. It will be described in terms of the geometry of a substrate and an electrically conductive pattern on the substrate. The substrate and electrically conductive pattern combine to form circuit elements, including a waveguide and a transmission line leading to the waveguide. Focusing on this geometry in order to introduce the nomenclature developed for this description and the claims, the transformer 10 includes a dielectric substrate 11 (FIGS. 1-5) having orthogonal X, Y, and Z axes and a plane of symmetry 12 (FIGS. 2-5) that contains the Y-axis and the Z-axis. The substrate 11 includes a first surface 13 (FIGS. 2-4) containing the X-axis and the Y-axis (and perpendicular to the plane of symmetry), an oppositely facing and spaced-apart second surface 14 (FIGS. 3-4) parallel to the first surface 13, and spaced-apart first and second sides 15 and 16 (FIGS. 2-5) that extend between the first and second surfaces 13 and 14 parallel to and on opposite sides of the plane of symmetry 12. This configuration can be achieved with a dielectric substrate in the form of a rectangular prism.

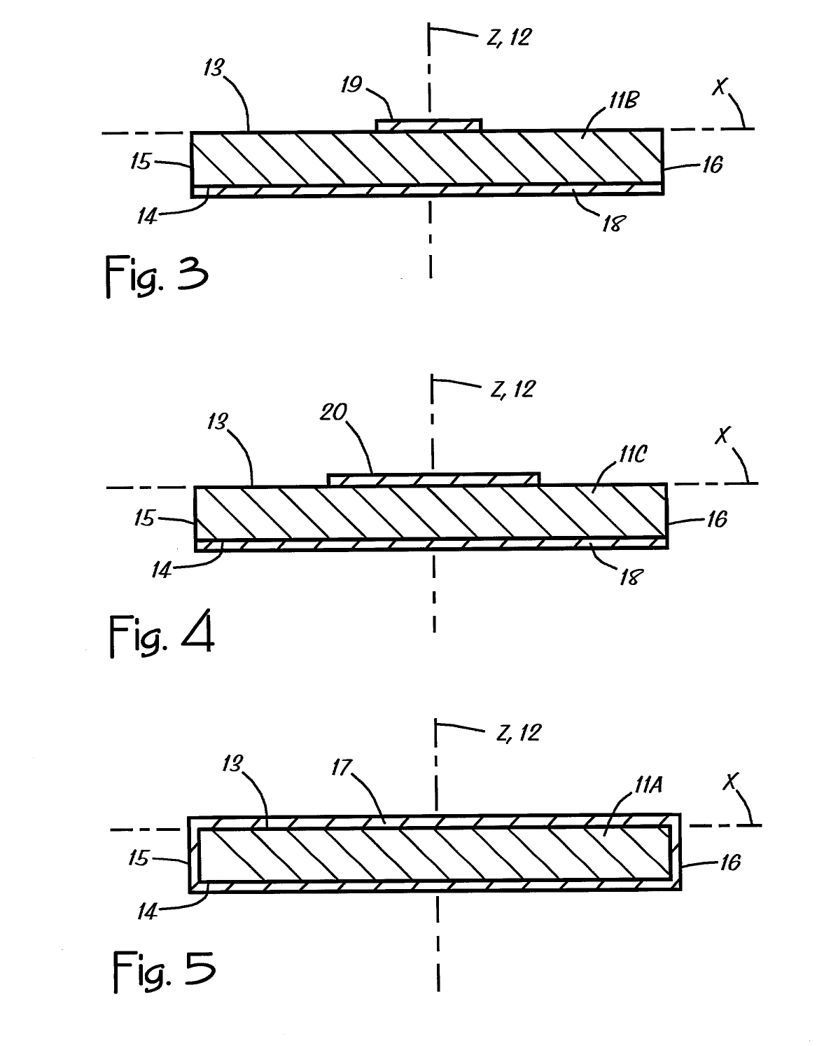

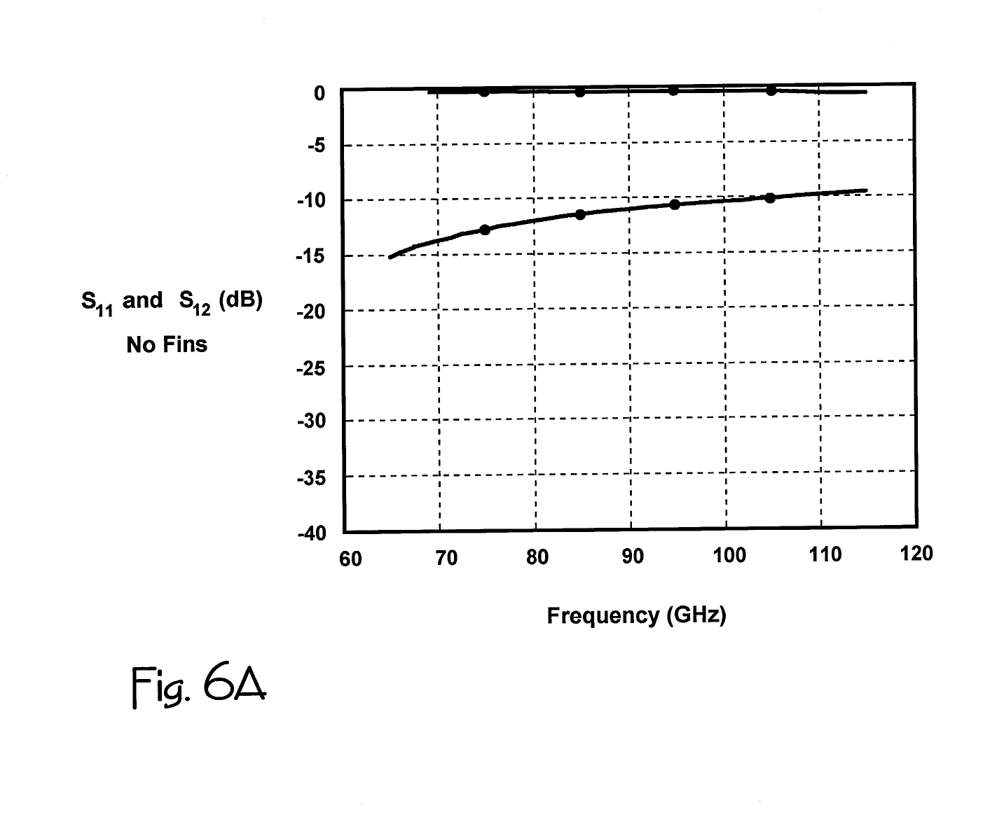

An electrically conductive pattern on the substrate 11 forms a dielectric waveguide and a dielectric transmission line extending to the waveguide. A waveguide portion 17 of the electrically conductive pattern (FIGS. 1, 2, and 5) on the first and second surfaces 13 and 14 and on the first and second sides 15 and 16, forms the dielectric waveguide on a far end portion 11A of the substrate 11 (FIGS. 2 and 5). The waveguide portion 17 and the waveguide it forms are disposed symmetrically relative to the plane of symmetry 12.

A groundplane portion 18 of the electrically conductive pattern (FIGS. 1, 3, and 4) on the second surface 14 extends from a near end portion 11B of the substrate 11 (FIGS. 2 and 3) to the waveguide portion 17. A transmission line portion of the electrically conductive pattern on the first surface 13 includes a first section 19 (FIGS. 1, 2, and 3) and a second section 20 (FIGS. 1, 2, and 4). The first section 19 extends to a junction 20A with the second section 20 that is depicted in FIG. 2 by a dashed line, and the second section 20 (or matching structure) extends to a junction 20B with the waveguide portion 17 that is also depicted by a dashed line.

The first section 19 of the transmission line portion of the electrically conductive pattern extends along the Y-axis from the near end portion 11B of the substrate 11 toward the waveguide. Combined with the groundplane portion 18, the first section 19 forms a first segment of the transmission line. The second section 20 of the transmission line portion of the electrically conductive pattern (FIGS. 1, 2, and 4) extends along the Y-axis from the first section 19 to the waveguide. Combined with the groundplane portion 18, the second section 20 forms a second segment (or matching segment) of the transmission line. The first and second sections 19 and 20 of the transmission line portion of the electrically conductive pattern, and the first and second segments of the transmission line they form, are disposed symmetrically relative to the plane of symmetry 12.

The substrate 11 may be composed of Duroid or other suitable dielectric material, Duroid being a proprietary product of Rogers Corporation consisting of woven glass/PTFE laminates. The substrate 11 has a thickness (i.e., a Z-dimension) measured along the Z-axis, a width (i.e., an X-dimension) measured along the X-axis, and a length (i.e., a Y-dimension) measure along the Y-axis. The dimensions may vary according to the dielectric material and other design parameters. For purposes of this description, the dielectric substrate 11 is composed of Duroid 5880 with a dielectric constant of 2.2. It has a thickness of 127 microns, a width of 2020 microns, and a length that is determined by the application. With the waveguide portion 17 of the electrically conductive pattern covering the substrate 11 to form the dielectric waveguide, the waveguide has a thickness or Z-dimension equal to the 127-micron thickness of the substrate 11 and a width or X-dimension equal to the 2020-micron width of the substrate 11.

The first section 19 of the transmission line portion of the pattern has a width or X-dimension of 380 microns. That results in the first segment of the transmission line it forms having a 50-Ohm characteristic impedance. In addition, the first section 19 has a length or Y-dimension (determined by the particular application) that extends from a first port 1 (identified in FIG. 2) toward the waveguide portion 17, while the waveguide portion 17 has a length or Y-dimension (determined by the particular application) that extends from the second section 20 to a second port 2 (identified in FIG. 2). RF energy is coupled to or from the transformer 10 via the first and second ports 1 and 2. The RF energy propagates within the substrate 11 along the Y-axis.

The second segment of the transmission line formed by the second section 20 of the transmission line portion of the pattern serves the function of matching the transmission line to the dielectric waveguide for efficient energy transfer as reflected by the S-parameters discussed later in this description. To achieve that function, the second section 20 has a width or X-dimension different from the X-dimension of the first section 19 and a length or Y-dimension that combines with the X-dimension to result in characteristics for the second segment of the transmission line that achieve the desired impedance transformation.

The foregoing is a broad statement of the geometry of the transformer 10 and the second or matching segment of the transmission line. No fins are required. Low-loss, broadband performance results. According to one preferred embodiment, the second section 20 of the transmission line portion of the electrically conductive pattern (the matching structure) is wider than the first section 19 so that it introduces capacitance. In other situations, a narrower, inductive matching structure may be required.

The second section 20 of the transmission line portion of the pattern has a length or Y-dimension that the microwave PCB designer factors in with its width or X-dimension to achieve characteristics that provide a better match and energy transfer between the transmission line formed by the transmission line portion of the electrically conductive pattern (i.e., sections 19 and 20) and the waveguide formed by the waveguide portion 17. Based upon the foregoing and subsequent descriptions, one of ordinary skill in the art can readily design and fabricate a matching structure according to the invention to achieve broadband performance exceeding that of fin-line designs in U.S. Pat. No. 6,087,907. The matching section may be designed in EMPIPE 3D (a trademark of Agilent Corporation). It is an electromagnetic (EM) optimization tool available from Agilent Corporation that uses MFSS (a trademark of Agilent Corporation) to conduct finite element method (FEM) based EM simulations. The design of the matching section begins with a S-parameter plot on a Smith Chart. For the transformer 10, the Smith Chart shows that the element needed to match the structure is a capacitance at the junction 20B (FIG. 2). The X-dimension and Y-dimension of the section 20 are chosen through EMPIPE 3D to provide an optimum match.

Concerning transition performance, consider a rectangular waveguide when it is above cut-off. The rectangular waveguide can be thought of as many quarter wavelength strips (fins) extending from the center region and shorted at the far end (rectangular waveguide side wall). The central region of the rectangular waveguide can be approximated by a parallel-plate waveguide, provided it is above cut-off. To gradually transfer a microstrip transmission line to the parallel-plate waveguide, one needs fins. The fins help restrict the E-field within the substrate where the microstrip ends. Because a rectangular waveguide can also be equated to closely spaced fins, the transfer of E-field into the substrate is very good, even under no-fin conditions. Therefore, a broadband match for the transition is achieved when the impedance of the resulting parallel-plate line is approximately matched to the microstrip transmission line at the frequency of interest.

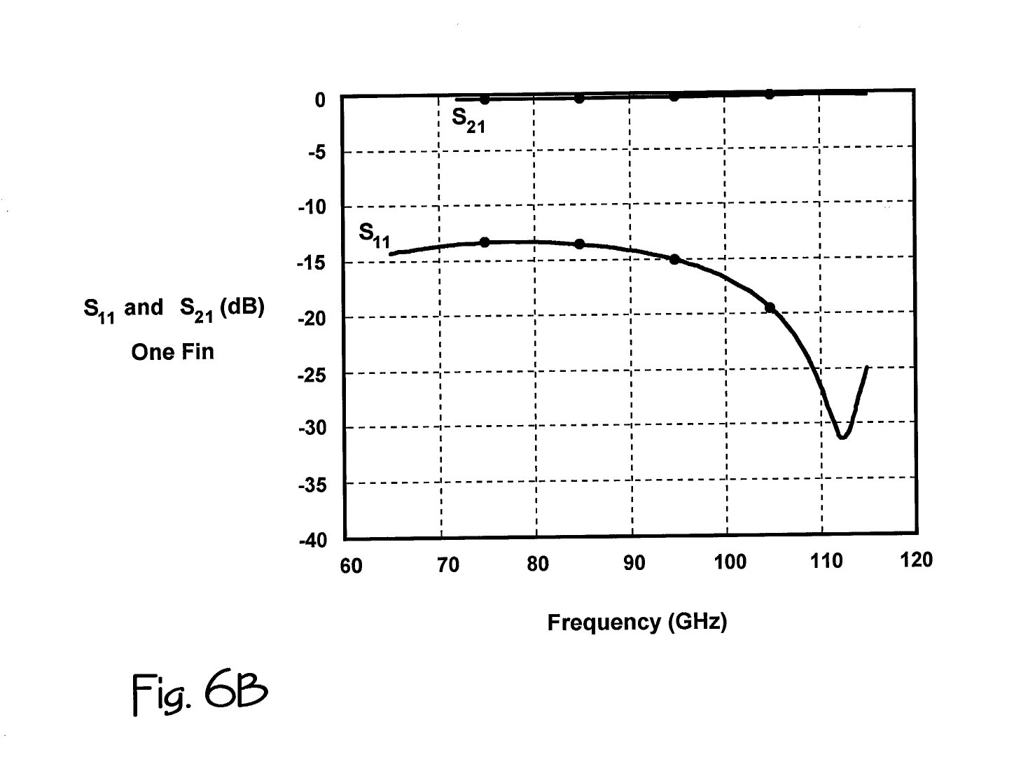

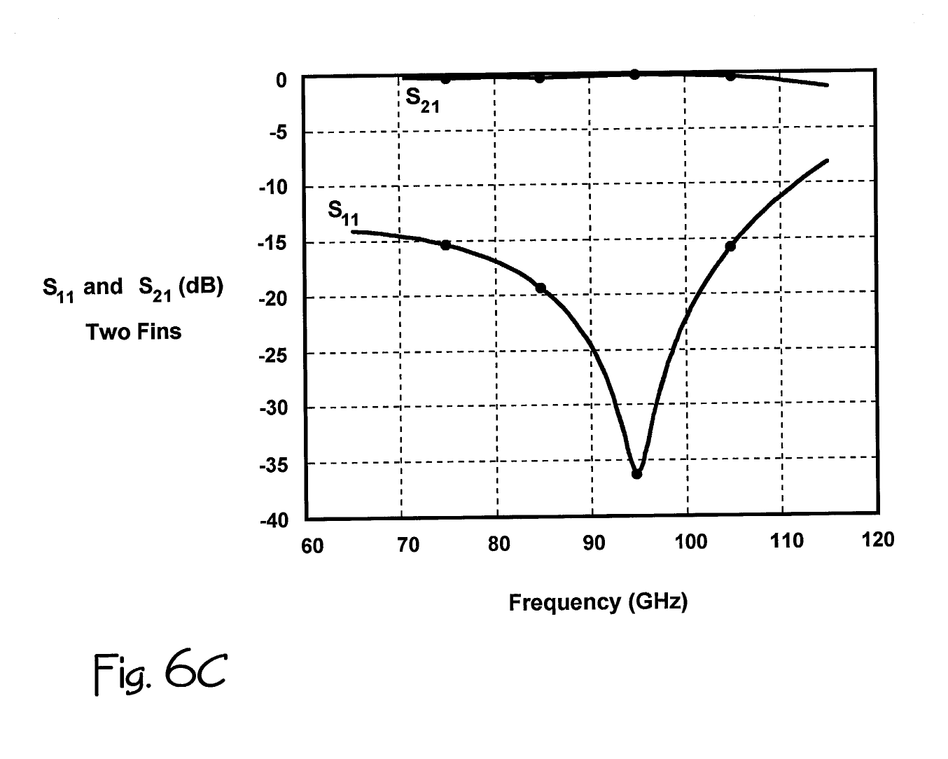

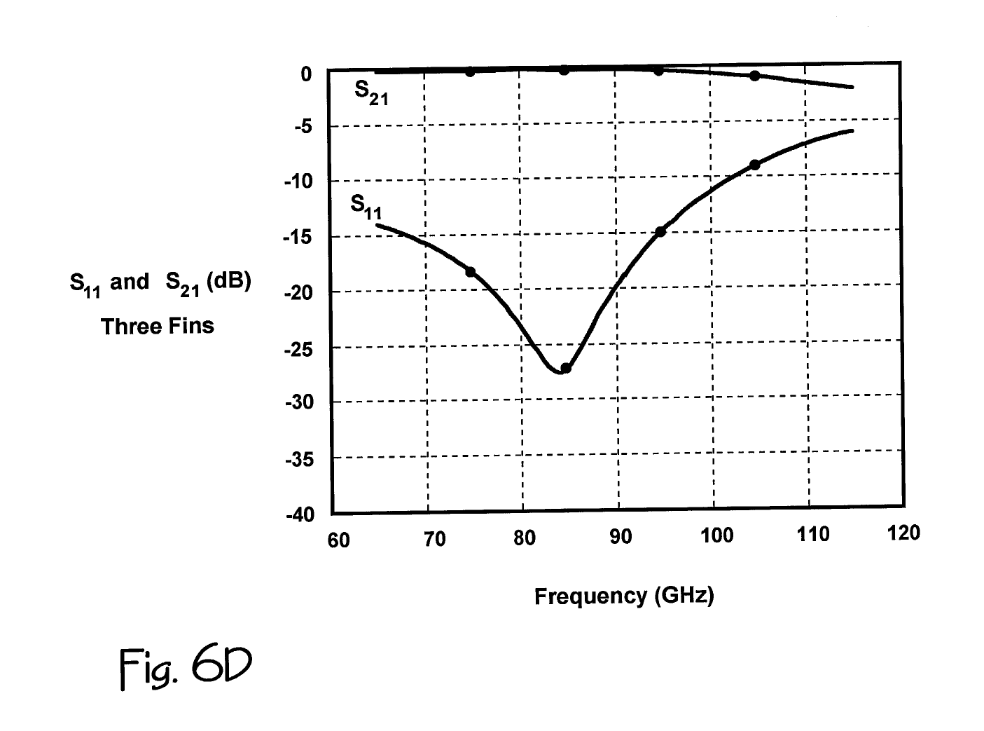

FIGS. 6A-6D show simulated results of a MS-to-RW mode transition implemented in 127-micron thick Duroid. The microstrip transmission line is nominally 50-Ohms and is 380 microns wide, while the rectangular waveguide width is 2020 microns. The S-parameters are in the natural impedance of the transmission line and, thus, reflect the characteristics of the mode transformer. Simulations show that the radiation loss at the transition is about 0.15 dB per transition and the operating bandwidth is from 65 GHz to 90 GHz. Also shown in FIGS. 6A-6D is the result of reducing the number of fingers. It is clear that the number of fins can change the frequency where the optimum match is achieved.

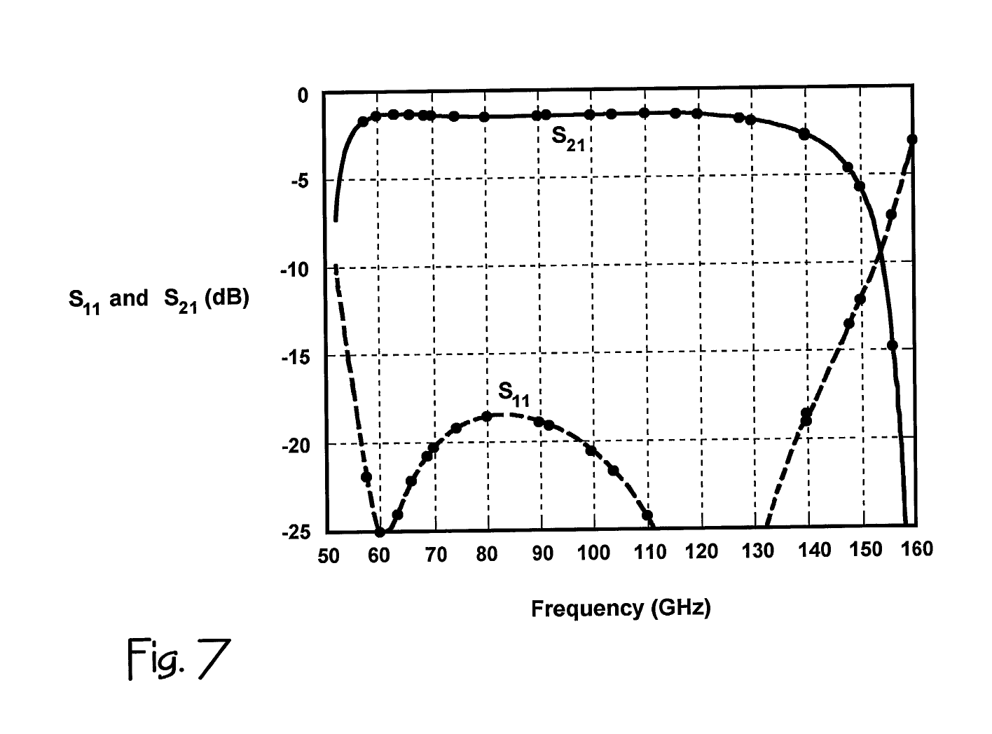

Better performance is obtained by using no fins. For the no-fin case, introducing a slight capacitance at the junction can optimize the performance for the stated substrate dimensions. Other structures may require an inductive element. FIG. 7 shows the EM-optimized performance with the S-parameters referred to the natural impedances of the transmission line. A better than 15 dB return loss is obtained for 60 GHz to 140 GHz. bandwidth. The patch at the junction implements the matching capacitance. It measures 342 microns long and 655 microns wide. With different dimensions or material, an inductive (or narrow) line may be more suitable. Thus, instead of fins, different matching structures can be used.

The transition of this invention provides improved and easier matching that can be used for many differing applications. The base plate of a millimeter-wave package can have multi-section rectangular waveguide sections, for example, that can transform the waveguide impedance into free-space impedance and in the process turn it 90 degrees. The resultant transmission line to waveguide mode transition is process insensitive. It enables the mounting of MMICs on top of a Duroid substrate for millimeter-wave applications even when line lithography may not be very well controlled. In addition, the transition is usable for broadband packages, couplers, splitters, and transitions. For ease of manufacturing, the edge wall can be replaced by continuous ground via mimicking the continuous ground wall. Via are plated holes through the substrate 11. For some other substrates (e.g., GMIC from M/A-com), they are solid mesa that bring grounds up the surface. Thus, via are connections between surfaces 13 and 14, usually accomplished by a hole or a solid pillar. Inasmuch as the transition of this invention allows easy PCB-based MS-to-RW mode transition, it enables waveguide filters in the substrate to be built where via could be used as inductive and/or capacitive elements

Concerning design procedures, a broadband match for the transmission line to waveguide mode transition is achieved when the impedance of the transmission line is matched to the waveguide at the frequencies of interest. Since the electric current is continuous across the transition, the Z_{PI} (power-current impedance) is the appropriate impedance to calculate using the following equation:

$${Z}_{PI} = 465 \frac{b}{a \sqrt{{ϵ}_{r}}} \frac{1}{\sqrt{1 - {( \frac{{f}_{c}}{f} )}^{2}}}$$

where “a” represents the width or X-dimension of the dielectric waveguide formed by the waveguide portion 17 of the pattern and “b” represents the thickness or Z-dimension, while “εᵣ” is the relative dielectric constant of the dielectric substrate 11 and f_{c} is the cut-off frequency of the waveguide. From this equation and a microstrip transmission line impedance of 50 Ohms, the return loss for the transmission line to waveguide mode transformer 10 is obtained. The bandwidth of the transformer 10 is determined by considering the TE_{N0} modes. For a practical region of interest, N=1,2,3 are the most important modes. The cut-off frequencies of these modes are spaced in a ratio of 1:2:3. The TE₂₀ mode is orthogonal to the microstrip mode and is not excited at a symmetric junction. So, the transformer between the MS-to-TE₁₀ mode is restricted once the TE₃₀ mode is excited.

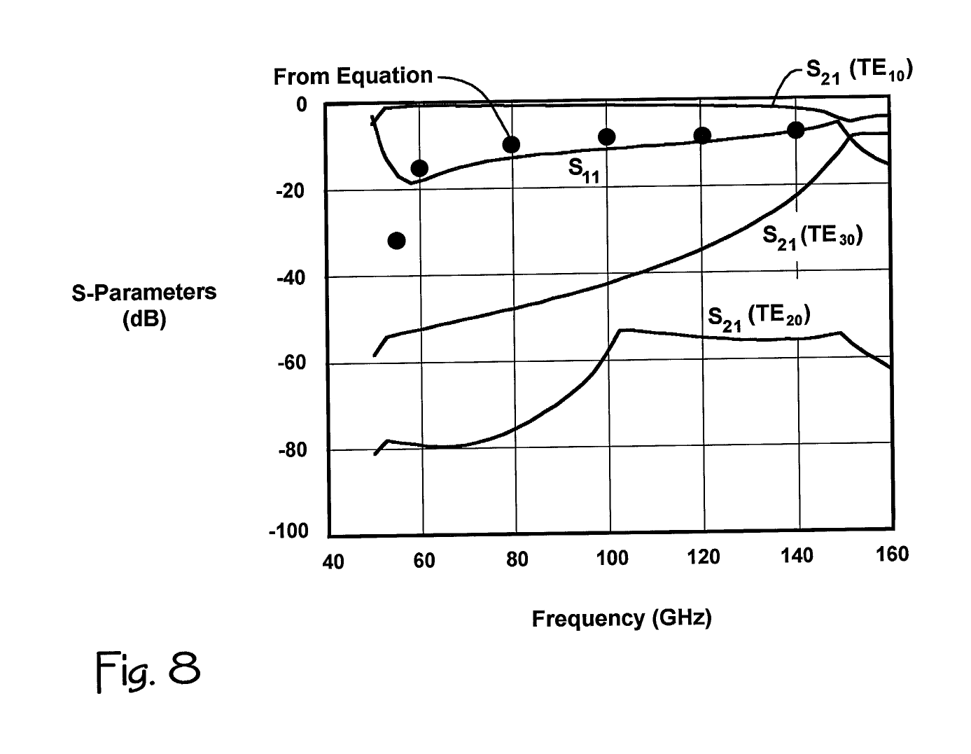

In practical situations, the dielectric substrate is predetermined due to a number of reasons such as microstrip losses, device implementation, packaging issues, and substrate availability. A popular PCB design substrate for mm-wave applications is RT/Duroid 5880 with a dielectric constant of 2.2 and a thickness of 127 microns. On this substrate, if the cut-off frequency of the TE₁₀ mode is chosen to be 50 GHz, then “b” is calculated to be 2020 microns. FIG. 8 shows the Ansoft HFSS simulated S-parameters between the transmission line (port 1) and various modes on the dielectric waveguide (port 2) for a one-millimeter long microstrip transmission line (50-Ohm nominally −380 microns wide) and a one-millimeter long rectangular dielectric waveguide. Ansoft HFSS is a registered trademark of Ansoft Corporation of Pennsylvania. Also plotted are the S-parameters based on the impedance definition given in the equation for Z_{PI} stated above.

Thus, this theory clearly predicts the return loss. The excitation of the TE₂₀ mode is low across the entire frequency band. Breakpoints in the TE₃₀ mode at about 100 GHz and in the TE₃₀ mode at 150 GHz correspond to the rectangular waveguide cut-off frequencies. Since the impedance of the waveguide is smaller than that of the transmission line, a stepped impedance transformer with simple matching structure are implemented in the EM simulator to match the transition.

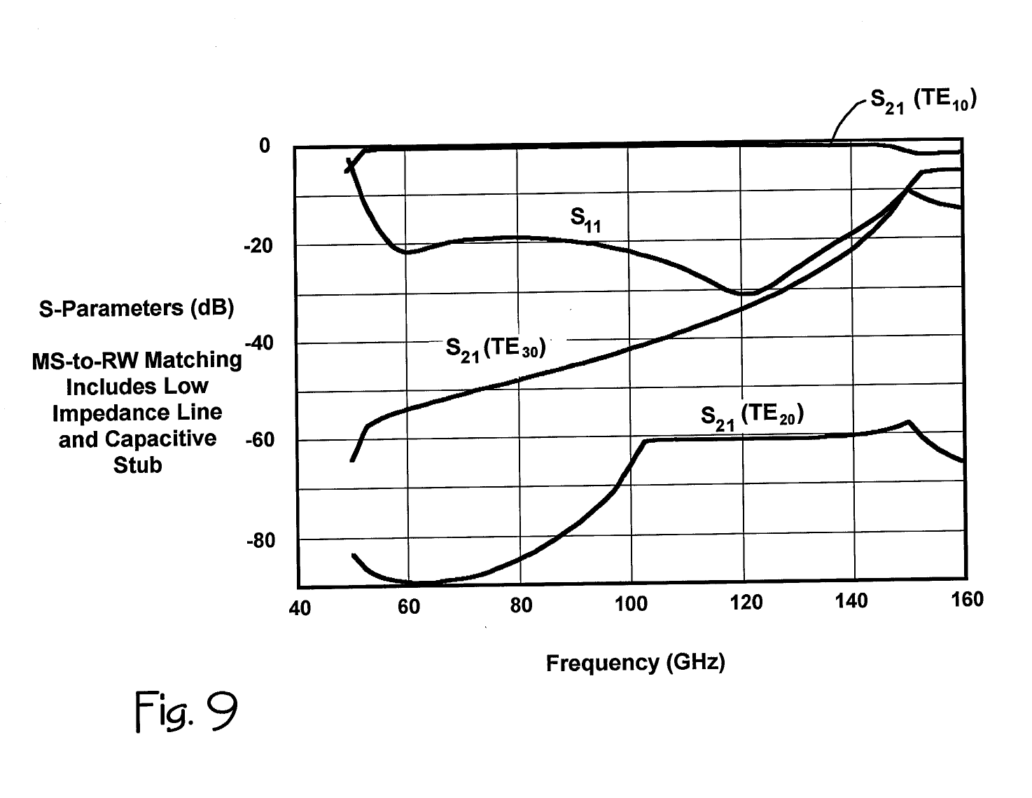

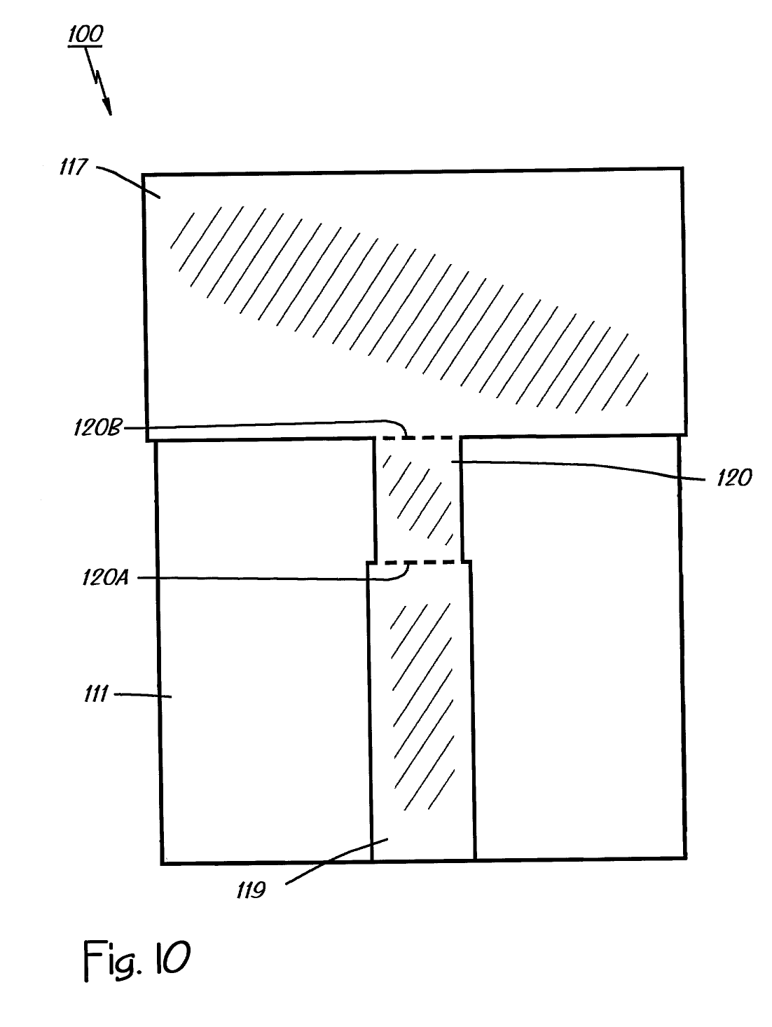

FIG. 9 shows an EM-optimized match for the transmission line to waveguide mode transformer 10. Better than 18-dB return loss is obtained over a 60-140 GHz bandwidth, showing the broadband nature of the transition. The match is sufficiently good for most practical applications.

As mentioned previously, the second or matching segment of the transmission line may be wider than the first section (capacitive) or narrower (inductive). FIG. 10 illustrates the inductive case with a transformer 100. The transformer 100 is similar in many respects to the transformer 10 and so only differences are described in further detail. For convenience, numerals designating parts of the transformer 100 are increased by one hundred over those designating corresponding, similar, or related parts of the transformer 10.

The transformer 100 includes an electrically conductive pattern on a substrate 111. A waveguide portion 117 of the pattern forms a dielectric waveguide. A transmission line portion of the pattern includes first and second sections 119 and 120 that form a transmission line extending to the waveguide. The first section 119 extends to a junction 120A with the second section 120, and the second section 120 extends to a junction 120B with the waveguide portion 117, with the second section 120 being narrower than the first section (i.e., inductive). As with the transformer 10, multi-stage matching may be used.

Thus, the invention provides a transmission line to waveguide mode transformer with an ultra-broadband transition that does not rely on resonance phenomenon for coupling. The transformer exhibits excellent isolation between two adjacent transitions, it is process tolerant, and it is readily fabricated with known PCB technology. Although exemplary embodiments have been shown and described, one of ordinary skill in the art may make many changes, modifications, and substitutions without necessarily departing from the spirit and scope of the invention. For example, the matching section of the transmission line may be of nonuniform width along a portion of its length and such a configuration is intended to fall within the scope of the broader claims that follow.

What is claimed is:

1. A transmission line to waveguide mode transformer, comprising:
a substrate; and
an electrically conductive pattern on the substrate that forms a waveguide and a transmission line extending to the waveguide;
the electrically conductive pattern including a waveguide portion and a transmission line portion extending to the waveguide portion;
the transmission line portion of the pattern including a first section that forms a first segment of the transmission line removed from the waveguide; and
the transmission line portion of the pattern including a second section that forms a second segment of the transmission line extending from the first segment of the transmission line to the waveguide, which second segment has characteristics that help match the first segment to the waveguide.

2. A transmission line to waveguide mode transformer as recited in claim 1, wherein the second section of the transmission line portion of the pattern is wider than the first section so that the second segment of the transmission line has lower impedance than the first segment.

3. A transmission line to waveguide mode transformer as recited in claim 1, wherein the second section of the transmission line portion of the pattern is narrower than the first section so that the second segment of the transmission line has a higher impedance than the first segment.

4. A transmission line to waveguide mode transformer as recited in claim 1, wherein the transmission line is a microstrip transmission line and the waveguide is a rectangular waveguide.

5. A transmission line to waveguide mode transformer as recited in claim 1, wherein the second section of the transmission line portion of the pattern has a uniform width.

6. A transmission line to waveguide mode transformer as recited in claim 1, wherein:
the first section of the transmission line portion of the pattern has a first width;
the second section of the transmission line portion of the pattern has a second width; and
the second width is different from the first width for at least a portion of the second section.

7. A transmission line to waveguide mode transformer as recited in claim 1, wherein:
the first section of the transmission line portion of the electrically conductive pattern has a first width; and
the second section of the transmission line portion of the electrically conductive pattern has a second width different from the first width and a length resulting in desired matching characteristics.

6. A transmission line to waveguide mode transformer, comprising:
a substrate having orthogonal X, Y, and Z axes, a plane of symmetry containing the Y and Z axes, and parallel first and second surfaces perpendicular to the plane of symmetry; and
an electrically conductive pattern on the substrate that forms a waveguide disposed symmetrically relative to the plane of symmetry and a transmission line extending to the waveguide;
the electrically conductive pattern including a waveguide portion and a transmission line portion that extends to the waveguide portion;
the transmission line portion of the pattern including a first section extending along the Y-axis that forms a first segment of the transmission line; and
the transmission line portion of the pattern including a second section extending along the Y-axis from the first section to the waveguide portion that forms a second segment of the transmission line, which second section of the transmission line portion of the pattern has a size and shape resulting in desired matching characteristics.
